(19) United States
(12) Patent Application Publication
(10) Pub. No.: US 2002/0137421 A1
(43) Pub. Date: Sep. 26, 2002

(54) Method for controlling thermohysteresis during thermoforming of three-dimensional fibrous compound constructs and the product thereof

(76) Inventors: Katrina G. Desroches, Kannapolis, NC (US); Gary S. Hennel, Troutman, NC (US); Benjamin M. Nolan, Elmer, NJ (US); Marlene Storzer, Woodlands, NC (US); Julia A. Thompson, Los Alamos, NM (US)

Correspondence Address: ROCKEY, MILNAMOW & KATZ, LTD., TWO PRUDENTIAL PLAZA, STE. 4700, 180 NORTH STETSON AVENUE, CHICAGO, IL, 60601, US

(21) Appl. No.: 10/021,929

(22) Filed: Dec. 13, 2001

Related U.S. Application Data
(60) Provisional application No. 60/255,531, filed on Dec. 13, 2000.

(51) Int. Cl. D04H 5/02; D04H 1/46; D04H 3/10; B29C 35/08; B29C 59/00; B29C 43/22; D04H 3/14

(52) U.S. Cl. 442/411; 442/402; 442/409; 264/402; 264/503

(57) ABSTRACT

A method is disclosed of controlling the thermohysteresis of a homogeneous or layered fibrous pre-form, comprised at least in part of thermoplastic staple length fibers, such that the physical properties of the resulting molded three-dimensional compound construct are significantly enhanced. In particular, the thermohysteresis is the result of a specific thermal history comprising the treatment of a fibrous pre-form with an elevated temperature incubation period followed by a cooling period. A so-treated fibrous pre-form can be subsequently molded by conventional thermomolding methods to render improved toughness, strength and structural stability to a resulting molded construct.

### TECHNICAL BACKGROUND

The present invention relates generally to the method of forming a molded three-dimensional construct comprised of at least one fibrous thermoplastic component, and more particularly, to a method of controlling the thermal history of a homogeneous or layered fibrous pre-form comprised at least in part of thermoplastic staple length fibers such that the physical properties of the molded three-dimensional compound are significantly enhanced.

### BACKGROUND OF THE INVENTION

A considerable number of consumer durable articles are constructed, in part or whole, from components that have been formed from a generic base material into a contoured or three-dimensional shape by the application of heat and pressure. Typical base materials are selected from those polymeric and malleable metallic compositions exhibiting the capability to be thermoformed and yet retain the imparted shape upon removal from the molding apparatus for a period of time corresponding to the service life of the end-use article. Where the component is desired to be of a minimum thickness, sheet or film stock in single layer, laminate layer, or composite layer form, may be selected from the broadest range of base material compositions. However, when a component is desired to have a durable and stable loftiness or thickness without the weight penalty accrued from a construct comprising a quantity of laminated sheets, the range of suitable base materials is significantly reduced.

Components that have a significant thickness and are adversely affected by the weight penalty of a substantially solid construction are typified by automotive interior panels, appliance facings, domestic furnishings, and acoustic dampening shields. In place of solid base materials, alternate materials are selected whereby the composition includes entrained or encapsulated air volumes, such as that formation found in chemical catalyst foams and foamed thermoplastics, or a substructure of open interstices, as found in bulked fibrous mats.

Foams have been a very popular solution as a base material in the thermoforming of three-dimensional molded components. As is well known in the art, various open and closed cell foams have been employed as a base material. The formation of these foams comes at the cost of the creation of hazardous and toxic gases which must be properly controlled and vented from the workspace and require complex mixing and molding equipment. Further, it has been found that when such foams are used in the formation of laminate or composite constructs, hereafter referred to as compound molded constructs, the serviceable life-span is insufficient due to thermal- and photo-degradation with a corresponding performance loss of the foam layer. In recent years, there has been a general impetus in the art to find alternate materials as the environmentally deleterious fabrication side products and limited component performance of foam, in conjunction with issues of non-recyclability, have been found unacceptable and difficult to remedy.

Fibrous base materials have come into favor as a replacement for foams due to the ability to blend differing staple length, denier and polymeric composition fibers in the pre-formed mat so as to alter, or otherwise “tune”, the performance of the molded construct to the end-use application. Staple fibers can be selected from different deniers and staple lengths as well as mono-component or multi-component thermoplastic composition. It is also possible to include non-thermoplastic fibers into the thermoplastic blend, such as thermoset and natural fibers, to act as reinforcing elements and render a thermoformed three-dimensional compound composite having improved physical performance. However, such constructs exhibit a loss in composition homogeneity and, as a result, may only be recycled into same-composition constructs.

Developments in new light-weight, durable molded articles have resulted in a greater concern directed to the quantity of fibrous base material required to form the necessary components, the ultimate weight of that component with regard to performance, and the impact on the overall article weight. For example, in constructs such as interior automotive panels, the weight of the panel directly impacts upon the weight and ultimate efficiency of vehicle manufacture and operation, as well as, the resistance of the molded panel to deform or “sag”. In constructs such as acoustic dampening shields, as used in sound attenuation and abatement in theaters, a lighter weight article would require less hardware to hang or otherwise affix said panel.

The formation of fibrous material directly into a molded construct is a well known practice to those skilled in the art. A blend of fibers formed in to a precursor mat, followed immediately by thermoforming, is routinely practiced in the creation of component level constructs. U.S. Pat. No. 4,840,832 to Weinle, et al., is particularly representative of the state of the art, and is hereby incorporated by reference. The method disclosed by Weinle is appropriate when a heavy weight precursor mat is used, however, when the weight of the mat is decreased, and importantly, the thermal mass is decreased, the performance of the molded construct falls off to an unacceptable level. U.S. Pat. No. 6,322,658 to Byma, et al, discloses a composite headliner bonded together by differentially heating each layer to a predetermined temperature, inserting the layers into a mold, and then compressing the layers together. This method, however, does not allow for the optimal performance of physical properties, such as toughness and structural stability.

The present invention contemplates a method of forming a three-dimensional molded fibrous component whereby the thermal history of a homogeneous or layered fibrous pre-form, comprised in least in part of thermoplastic staple length fibers, is controlled such that the physical properties of the resulting compound construct are significantly enhanced. The present invention further contemplates that the improved physical properties as result of the practice of the disclosed method allow for a significant reduction in the basis weight of the resulting construct.

### SUMMARY OF THE INVENTION

Herein is disclosed a method of controlling the thermohysteresis of a homogeneous or layered fibrous pre-form, comprised at least in part of thermoplastic staple length fibers, such that the physical properties of the resulting molded three-dimensional compound construct are significantly enhanced. In particular, the thermohysteresis is the result of a specific thermal history comprising the treatment of a fibrous pre-form with an elevated temperature incubation period followed by a cooling period. A so-treated fibrous pre-form can be subsequently molded by conventional thermomolding methods to render improved toughness, strength and structural stability to a resulting molded construct.

An initial fibrous pre-form comprising a thermoplastic fiber is manufactured by conventional fiber lay-down technologies, such as carding followed by cross-lapping or air-laying. The fibrous pre-form is then subjected to an elevated temperature incubation period whereby at least a portion of the fibrous component comprising the pre-form reaches a molten state and fiber to fiber bonds are initiated. Upon cooling from the molten state, two related mechanisms are believed to occur. First, the fiber-to-fiber bonds solidify and form a durable integration of the fibrous material into a unified pre-form. Second, as the polymer component fibrous material returns to a cooled state, the molecular structure of the polymer component has been affected to yield an ultimate construct of enhanced physical properties. The combined effects of the two mechanisms are a fibrous pre-form that exhibits an elevated level of strength, which when reheated and molded into a three-dimensional construct by the application of heat and pressure, results in a construct having a higher performance level than a construct molded from an untreated pre-form.

The thermohysteretic effect so described is further enhanced by introducing a compression step after the initial elevated temperature incubation period and the cooling period. By this method, the heated pre-form is transferred to a compression molding station and the heated pre-form compressed to a depth in the range of less than the full fibrous pre-form thickness, but greater than or equal to the full molded construct thickness, then cooled by either active or ambient means. A final molded construct is then formed by re-heating the compressed pre-form to a second elevated temperature and compressing to the final depth and contour.

It is also envisioned that the elevated temperature incubation of the entire uncompressed fibrous pre-form is replaced by a means whereby only the outer surfaces of the fibrous pre-form are subjected to an elevated temperature. Suitable means for heating preferentially the outer surfaces of the fibrous pre-form include radiant heat sources. Once the outer surface of the fibrous pre-form has been heated, the pre-form may be cooled with or without a partial depth compression step.

The thermal history of the ultimate construct may also be controlled by means of maintaining thermal environment of the fibrous pre-form between the initial heating step and the final molding step. Such means for controlling the thermal environment include the use of one or more thermal isolation layers and the application of active heating elements well known in the art.

A thermal isolation layer may be fabricated from those materials having insulative properties, such as found in fluorocarbon based polymers, ceramics, and thermoset resins, in either a unitary sheet form or as a coating on the molding surface. A method employing the thermal isolation layer involves the temporary superimposing of a thermal isolation layer on the upper and lower surfaces of fibrous pre-form. The sandwiched fibrous pre-form is then subjected to an elevated temperature incubation period whereby at least a portion of the fibrous component comprising the pre-form reach a molten state. The heated and sandwiched pre-form is then transferred to a compression molding station and the heated pre-form compressed to the full depth of the final molded component. The molded pre-form is then removed from the mold and the thermal isolation layers detached, if required, revealing the completed three-dimensional molded component.

A compound construct is also envisioned by the above methods whereby a plurality of previously formed woven fabric, nonwoven fabric, or film facing layers, either alone or in conjunction with an adhesive, may be positioned in face to face juxtaposition with the fibrous pre-form during an intermediate compression step.

The present method has been practiced for controlling the thermohysteresis of a polyester sheath/core binder fiber and matrix fiber blend during the formation of a three-dimensional molded construct as well as three-dimensional molded compound constructs to obtain enhanced physical properties. As will be appreciated, the technique can be employed for enhancing the physical properties of the ultimate molded construct fabricated whereby a wide variety of fibers, fiber blends and facing layers are employed.

### BRIEF DESCRIPTION OF THE DRAWINGS

The invention will be more easily understood by a detailed explanation of the invention including drawings. Accordingly, drawings which are particularly suited for explaining the invention are attached herewith; however, it should be understood that such drawings are for explanation purposes only and are not necessarily to scale. The drawings are briefly described as follows:

FIG. 1 is a diagrammatic view of an apparatus for compressing a fibrous pre-form prior to molding;

FIG. 2 is a schematic view of the apparatus depicted in FIG. 1, whereby the apparatus is in operation;

FIG. 3 is a schematic view of the preferred means for mechanically needling the fibrous pre-form;

FIG. 4 is a schematic view of the preferred means for an indicative commercial process line.

FIG. 5 is a cross-sectional photomicrograph at 7.5x magnification depicting the fibrous interstitial structure of Comparative Example 1;

FIG. 6 is a top plan photomicrograph at 5.5x magnification depicting the surface topography of Comparative Example 1;

FIG. 7 is a cross-sectional photomicrograph at 7.5x magnification depicting the fibrous interstitial structure of Example 3;

FIG. 8 is a top plan photomicrograph at 5.5x magnification depicting the surface topography of Example 3; and

FIG. 9 is a cross-sectional photomicrograph at 7.5x magnification depicting the fibrous interstitial structure and outer nonwoven facing layers of Example 1.

### DETAILED DESCRIPTION

While the present invention is susceptible of embodiment in various forms, there is shown in the drawings and will hereinafter be described a presently preferred embodiment of the invention, with the understanding that the present disclosure is to be considered as an exemplification of the invention, and is not intended to limit the invention to the specific embodiment illustrated.

Application of the present invention begins with a fibrous pre-form comprising staple length fibers. The staple length fibers may be selected from those composed in part or whole of thermoplastic polymers. Suitable deniers for the fiber are typically in the range of about 1 to 20, with the range of 3 to 15 being preferred. Thermoplastic polymers suitable for this application include polyolefins, polyamides, and polyesters. The thermoplastics may be further selected from homopolymers, copolymers, and other derivatives including those thermoplastic polymers having incorporated melt additives or surface active agents. The profile of the fiber is not a limitation to the applicability of the present invention. It is anticipated that fibrous component of the fibrous pre-form comprise greater than about 50% by weight thermoplastic fibers so as to render the fibrous pre-form receptive to thermoforming procedures. The remainder of the fibrous component can be comprised of thermoset polymeric fibers and natural fibers.

A preferred embodiment of the present invention is the use of a blend of at least two different types of staple fibers. The first staple fiber type is a bi-component fiber having a polyester core component and a co-polyester sheath component. At an appropriate elevated temperature, the co-polyester sheath melts and flows into the fiber-to-fiber junctions and initiates fiber bonding, this type of fiber being referred to as a binder fiber. The second staple fiber type is a large denier polyester fiber, referred to as a matrix fiber. The purpose of the large denier polyester fiber is to impart resilience to the structure while being bonded by the binder fiber and maintaining polymeric homogeneity in the fibrous pre-form.

The staple length fibers are formed into a mat in order to facilitate handling during molded construct fabrication. Staple length fibers may be laid down into a fibrous batt by conventional methodologies such as the use of one or more cards. By employing fiber redistribution equipment downstream of the card or cards, fibers comprising the batt can be distributed and/or oriented such that fibrous batt is imparted with the benefit of the fiber directionality. Use of a cross-lapper has been found to be particularly beneficial in that the uniform distribution of the fibers oriented away from a 90° relative departure angle within the fibrous batt provides for potential improvement of machine direction and cross direction strength performance.

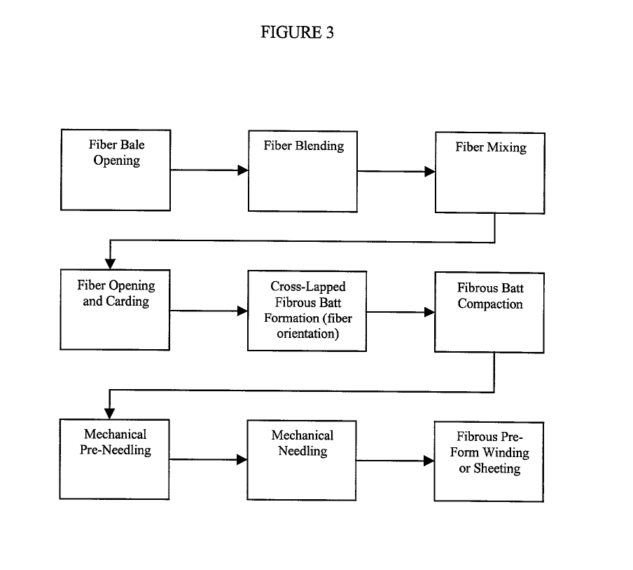

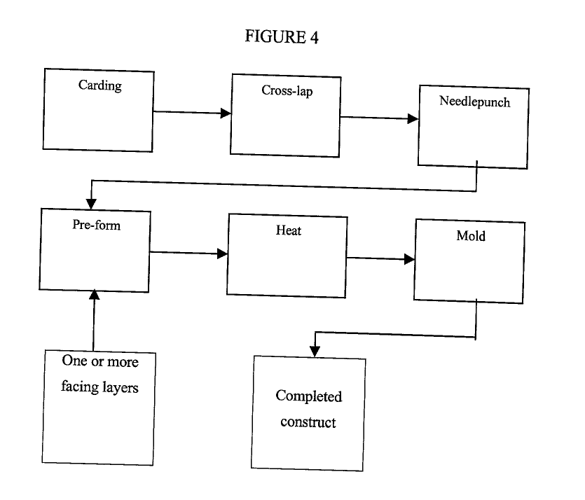

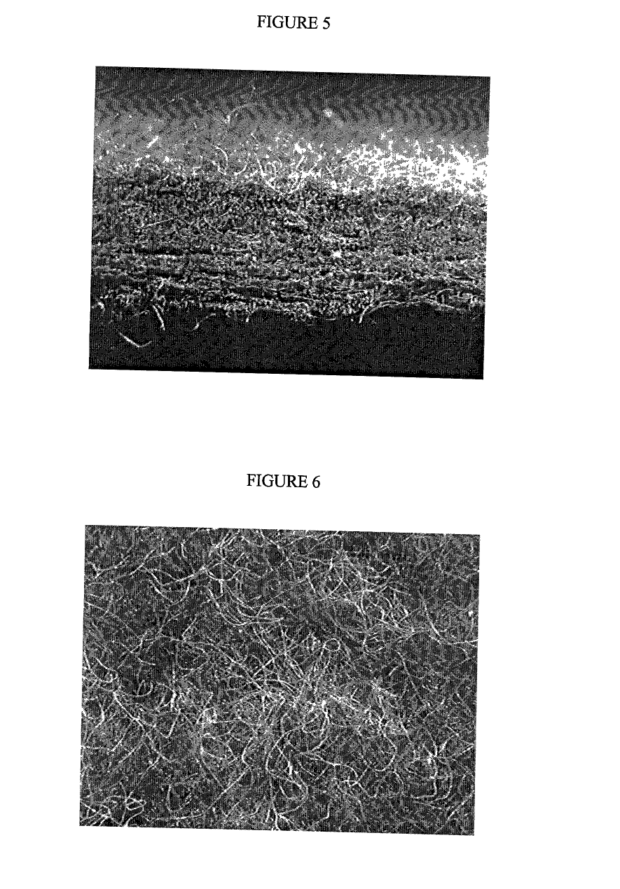

A fibrous batt has little inherent integrity, requiring a light to moderate consolidation of the fibrous batt into a fibrous pre-form mat. Mechanically needling, as shown in FIG. 3, has been the most preferred method as the mechanical entanglement can be readily adjusted depending on the processability requirements and yet does not introduce adhesive binders or other materials into the construction. A particular representative mechanical needling process includes the use of a compression belt to reduce the excessive bulk of the fibrous batt to a height suitable for mechanically needling, typically greater than 10:1 compression rate being used. The mechanical needling occurs in two incremental steps including the use of a pre-needler having less than about 100 punches per square inch with a Foster type needle and needler having greater than about 100 punches per square inch with a triangular type needle. Once formed into a mat, the fibrous pre-form may be either wound into a roll or cut into sheets for later processing. In order to thermally treat the fibrous pre-form, the fibrous pre-form is placed in either an elevated temperature environment or in contact with an elevated temperature surface. Whether in continuous or finite dimension sheet form, the fibrous pre-form can be treated with a continuous flow of heated air in a convection oven. Once the fibrous pre-form sheet has reached a predetermined elevated temperature, the sheet is optionally compressed, then allowed to cool. A compression operation can be in either the form of a flat, crenulated or fluted surface based on either a press platen for finite dimension sheets or as a nip in appropriately formed calender rolls for continuous roll material.

Cooling of the heated fibrous pre-form below its activation temperature can occur by either active or ambient means. Depending upon processing constraints, including line speed and equipment footprint, selected cooling means are employed appropriate to those constraints. When employing a high line speed whereby the residence time will be necessarily short, an active cooling environment would expedite processing. Alternately, if finite dimension sheets are to be formed, the residence time in conveying, sorting, and stacking may be sufficient for ambient temperature cooling.

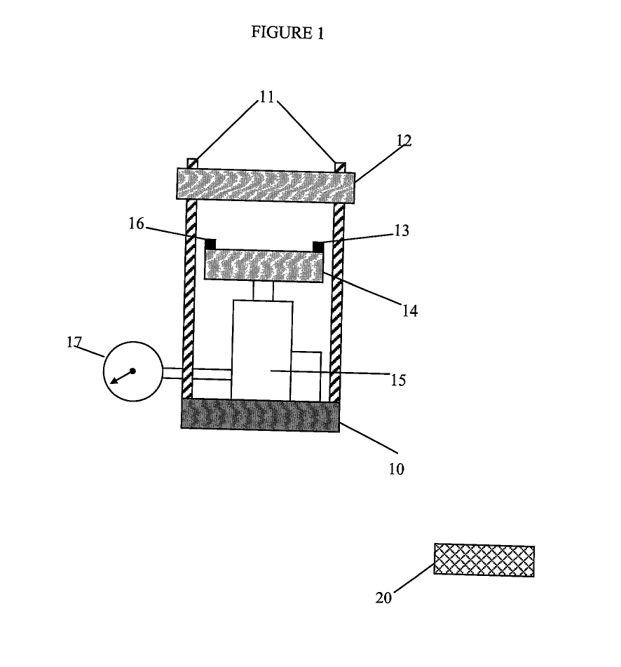

The particular apparatus employed in the compression of the prototypical fibrous pre-forms of the present invention is depicted in FIG. 1. A hydraulic ram 15 is affixed to base 10, the base further comprising uprights 11 for securing upper platen 12. Attached to the hydraulic ram 15 is lower platen 14. Lower platen 14 moves relative to upper platen 12 by actuating the hydraulic ram 15 and applying pressure as measured by gauge 17. To prevent full depth compression of the fibrous pre-forms, key-stock spacing shims 13 and 16 are interposed between lower platen 14 and upper platen 12 to create a chamber of finite height determined by the key-stock selection. Upper platen 12 and lower platen 14 can also be independently heated, for hot-press forming the construct, when an elevated surface temperature is desired.

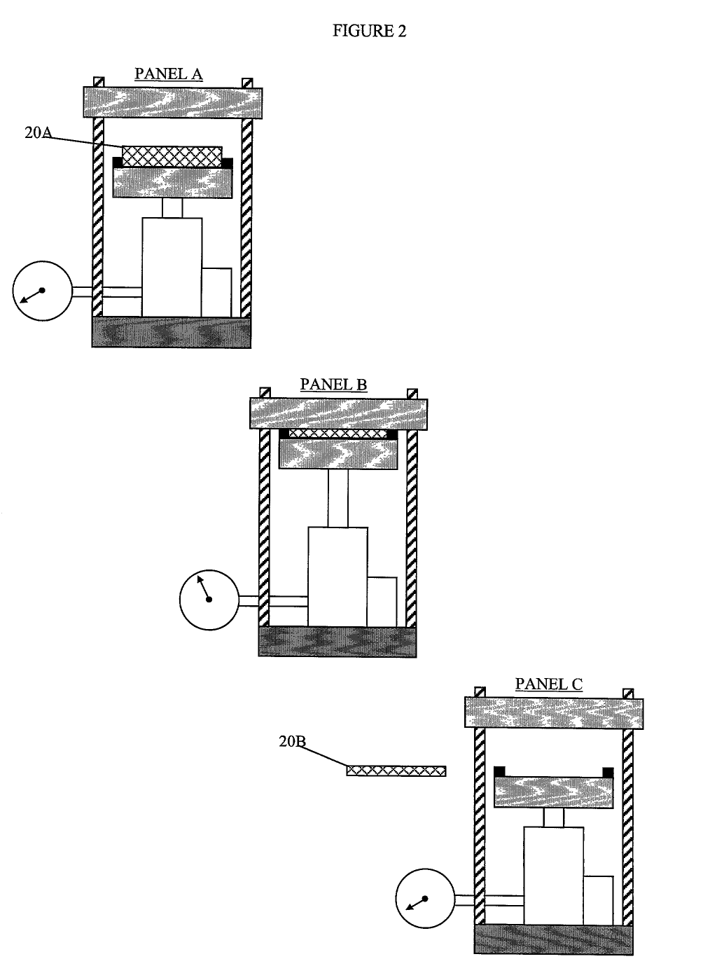

The application of the compression apparatus is shown in FIG. 2. In Panel A, a pre-heated fibrous pre-form 20A having a first thickness is placed between the spacing shims. The hydraulic ram is actuated, raising the lower platen until such point the spacing shims impact upon the upper platen, as shown in Panel B. The platens are allowed to remain in this position and at the predetermined pressure for a finite duration. In Panel C, the expiration of this finite duration results in releasing the hydraulic ram, thus lowering the lower platen. The now compressed fibrous pre-form 20B, having a second thickness less than the first thickness, is then removed.

Once the thermally treated fibrous pre-forms have been fabricated, conventional forming technologies can be employed to yield improved performance molded constructs.

It is within the purview of the present invention that a compound construct can be formed during the thermal cycle process. Compound constructs are molded fibrous pre-forms that further comprise one or more layers of thin preformed materials as facing layers. The combination of a facing layer or facing layers on a fibrous pre-form results in a molded construct exhibiting better physical performance than the core exhibits alone. It is proposed that the facing layers in conjunction with the fibrous pre-form result in the performance characteristics of a structure often referred to as an “I” beam composite. Suitable materials for the facing layer include woven fabrics, nonwoven fabrics, and films.

### EXAMPLES

It is hereby declared that the resultant molded constructs prepared by the following examples are within a standard deviation of 10% in respect to construct basis weight and part depth.

### Comparative Example 1

A thermoformed material was fabricated utilizing a standard heavy weight fibrous pre-form. The fibrous pre-form consisted of 25% by weight 15.0 denier by 3.0 inch staple length polyester matrix fiber with approximately 10 crimps per inch, as available as Kosa fiber type 295, blended with 75% by weight 4.0 denier by 2.5 inch staple length carbon doped co-polyester/polyester sheath/core binder fiber with approximately 10 crimps per inch, as Kosa fiber type C58. The weight of the pre-form was 1765 grams per square meter (gsm).

The heavy weight fibrous pre-form was placed into a Lab-Line Instruments' Laboratory convention oven, model Imperial IV, and heated for 10 minutes at 180° C. Upon completion of the incubation period, the heated pre-form was immediately transferred to a Carver Press, Model C, as shown in FIG. 1 and FIG. 2. Two 3.2 mm key-stock spacing shims were previously set in position on the left-hand and right-hand side of the lower platen and the heated pre-form was set in between these shims. The platens were at an ambient temperature of approximately 22° C. The hydraulic ram was then actuated until such point the lower and upper platens made contact on the spacing shims. At this point, the hydraulic ram continued applying pressure to the spacing shims until a pressure level of at least 1000 pounds per square inch was reached. The mold was allowed to remain in this position for 1.75 minutes.

### Comparative Example 2

A similar material as described in Example 1, whereby in the alternative, a compound construct utilizing a light weight fibrous pre-form and an upper and lower layer of previously constructed nonwoven fabric/adhesive were applied. The approximate weight of the pre-form was 700 grams per square meter. A nonwoven fabric was employed as an outer facing. The nonwoven fabric consisting of a polyester/co-polyester carded staple fiber unified into a cohesive fabric by the application of through air thermal bonding and had a final basis weight of 144 gsm. An adhesive film was also employed to further enhance adhesion of the nonwoven layer to the fibrous pre-form. The adhesive film was a type 5209 polyester based adhesive film as supplied by Bemis Associates, Inc. of Shirley, Mass.

A layered pre-form was set in the convection oven and incubated at 180° C. for 7 minutes. The layered pre-form consisted of a first layer of carded staple, through air bonded nonwoven, a first layer of polyester based adhesive film, the light weight fibrous pre-form, a second layer of polyester based adhesive film, and a second layer of carded staple, through air bonded nonwoven. Upon completion of the incubation period, the heated, layered pre-form was placed in the Carver Press. A 5 mm spacing shim was employed and a duration at compression of 2.0 minutes.

### Comparative Example 3

A similar material as described in Comparative Example 1, whereby the weight of the fibrous pre-form was 1711 gsm, the pre-form was incubated at 180° C. for 10 minutes and was cold pressed at an excess of 1000 pounds per square inch on 5.0 mm spacing shims for 1.75 minutes.

### Comparative Example 4

A similar material as described in Comparative Example 3, whereby the weight of the fibrous pre-form was 945 gsm, the pre-form was incubated at 180° C. for 4.25 minutes and was cold pressed at an excess of 1000 pounds per square inch on 5.0 mm spacing shims for 1.25 minutes.

### Comparative Example 5

A similar material as described in Comparative Example 2, whereby the weight of the fibrous pre-form was 684 gsm. The layered fibrous pre-form further comprised an upper and lower thermal isolation layer in contact with the nonwoven layer, positioned away from the fibrous pre-form layer. The thermal isolation layer consisted of a nominal 0.9 mm thickness fluorocarbon polymer sheet available as a Teflon product from the Du Pont Corporation. The entire layered fibrous pre-form with thermal isolation layers was elevated to the temperature of 180° C. for 7 minutes before molding. Spacing shims of 7.3 mm were employed to compensate for the additional thickness of the two thermal isolation layers and, again, a compression duration of 2.0 minutes was employed.

### Comparative Example 6

A similar material as described in Comparative Example 5, whereby two nonwoven layers consisting of 144 gsm thermally bonded polyester/co-polyester staple fiber were affixed to outer surfaces of the fibrous pre-form without the use of an adhesive binder layer. Spacing shims of 7.3 mm were used.

### Comparative Example 7

An un-insulated fibrous mat was treated in a continuous process whereby the surface was heated to a sufficient temperature to activate the binder while under compression of or about 3 mm. It was then cooled below the activation temperature and the pressure released.

### Example 1

A thermoformed material fabricated by the present invention comprised a layered fibrous pre-form as described in Comparative Example 2, whereby the layered fibrous pre-form was initially heated at 180° C. for 4.25 minutes, then cooled to 22° C., then layered as described. The entire layered fibrous pre-form with thermal isolation layers was elevated to the temperature of 180° C. for 7 minutes before molding. Spacing shims of 7.3 mm were employed to compensate for the additional thickness of the two thermal isolation layers and, again, a compression duration of 2.0 minutes was employed.

### Example 2

A thermoformed material fabricated by the present invention comprised a fibrous pre-form as described in Comparative Example 4, whereby the fibrous pre-form was initially heated a 180° C. in a convection oven for 4.25 minutes. The heated pre-form was then compressed in excess of 1000 pounds per square inch on 5.0 mm key-stock shims for 1.75 minutes. The compressed pre-form was then allowed to cool to 22° C. under ambient conditions. The cooled, compressed fibrous pre-form was then compressed on 5.0 mm shims between heated platens, the platens being at about 190° C., for a duration of 1.0 minute.

### Example 3

A thermoformed material similar to Example 2, whereby the heated pre-form was instead compressed using 7.2 mm key-stock shims followed by cooling and hot press forming on 5.0 mm shims.

### Example 4

A thermoformed material similar to Example 2, whereby a 700 gsm fibrous pre-form was initially heated for 3.0 minutes at 180° C., then cooled to 22° C. Two nonwoven facing layers consisting of 144 gsm thermally bonded polyester/co-polyester staple fiber, where subsequently applied, and the compound construct compressed on 5.0 mm shims at 180° C. for 1 minute.

### Example 5

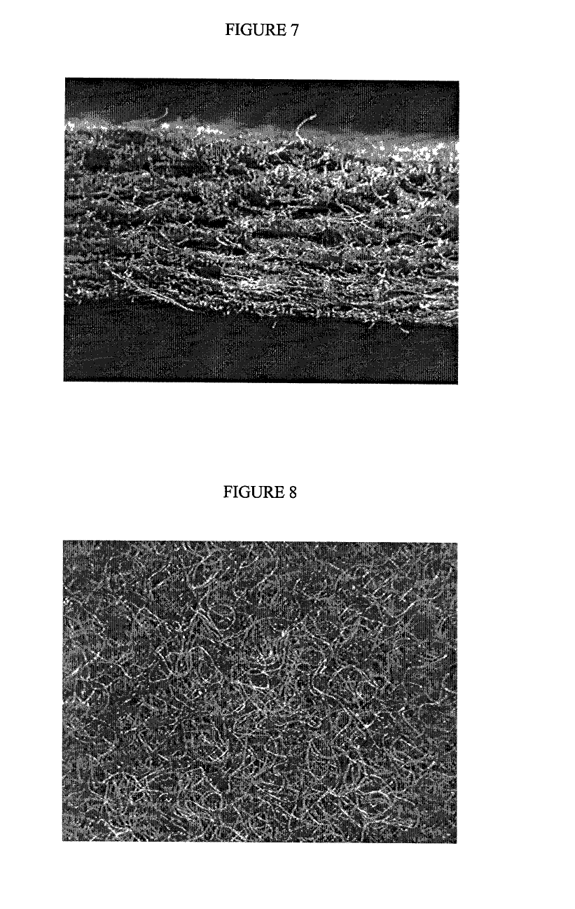

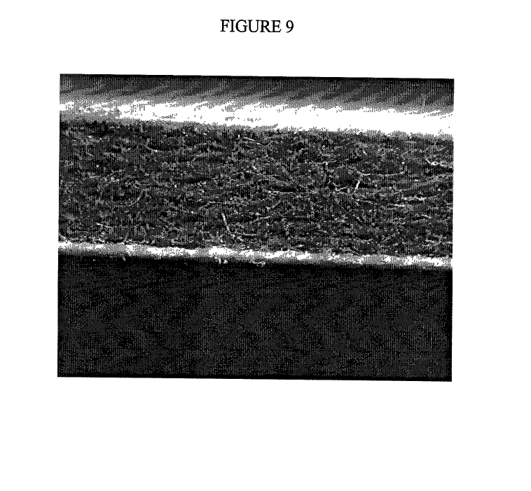

A thermoformed material similar to Comparative Example 1, whereby rather than heating in a convection oven, the outer surfaces of the fibrous pre-form were placed in direct contact with an elevated temperature radiant heat source of at least 180° C. until such time the fibers at the face of the fibrous pre-form are integrated. This surface topography is depicted in the untreated material as shown in FIG. 5 versus the treated material in FIG. 7. The surface heated fibrous pre-form is then allowed to cool at an ambient temperature of 22° C. The pre-form is then heated for 7 minutes at 180° C. in a convection oven. Thermal isolation layers were utilized in conjunction with 7.3 key-stock shims, as previously described, while the heated pre-form was then compressed in excess of 1000 lbs. for 2 minutes.

### Example 6

A thermoformed material similar to Comparative Example 6, whereby the outer surfaces of the fibrous pre-form were exposed to an elevated temperature radiant heat source of 180° C. for 1 minute, cooled to an ambient temperature of 22° C., then used as the pre-form in conjunction with the nonwoven facing layers and thermal isolation layers. The adhesive layers were deleted.

### Example 7

An insulated fibrous mat was treated in a continuous process whereby the surface was heated to a sufficient temperature to activate the binder while under compression of or about 3 mm. It was then cooled below its activation temperature and the pressure released.

### Example 8

A fibrous mat was treated in a continuous process whereby the surface was heated to a sufficient temperature to activate the binder while under compression of or about 3 mm. It was then cooled below its activation temperature and the pressure released. This pre-form was then thermoformed with two adhesive coated facing layers of through-air bonded, carded fibers and an additional aesthetic layer.

### Example 9

A fibrous mat, and two adhesive coated facing layers, were treated in a continuous process whereby the surface of the mat reached a temperature sufficient to activate the binder component while under compression of or about 3 mm. The construct was then cooled below the activation temperature and the pressure released. This pre-form was then thermoformed with an additional aesthetic layer.

Each of the above materials was tested for performance after being allowed to rest at an ambient temperature of 22° C. for at least 24 hours. Data provided in Tables 1-5 show the results of performing a three-point flex test derived from ASTM D-790 on 3 inch by 6 inch samples. Testing parameters include the use of a Model 1122 Instron utilizing a 50 pound compression cell. The nosepiece consisted of a 0.3 cm radius by 5.5 cm width. The test span consisted of two 1.2 cm diameter rests separated by 9.53 cm. Table 5 reflects the results of an indicative commercial scale process line.

Table 1 and Table 3 both illustrate two constructs developed in a comparative manner, wherein one construct was developed utilizing two thermal isolation layers and the other construct was developed devoid of the thermal isolation layers. The constructs that were developed utilizing the thermal isolation layers showed an improvement in stiffness over those constructs developed devoid of the thermal isolation layers. Table 2 shows two constructs also developed in a comparative manner at a lower basis weight, however, the construct in Example 5 comprises additional fabric layers which in turn increases the stiffness of the construct. Table 4 embodies data reflective of an indicative commercial line process, wherein the stiffness improvement is fully exhibited.

TABLE 1

| Part Identification | Basis Weight | Part Depth | Stiffness |
|---|---|---|---|
| Comparative Example 2 | 1154 | 4.9 | 1.9 |
| Example 1 | 1189 | 5.4 | 6.8 |

TABLE 2

| Part Identification | Basis Weight | Part Depth | Stiffness |
|---|---|---|---|
| Comparative Example 5 | 684 | 5.2 | 0.64 |
| Example 5 | 693 | 5.4 | 0.73 |

TABLE 3

| Part Identification | Basis Weight | Part Depth | Stiffness |
|---|---|---|---|
| Comparative Example 6 | 965 | 5.5 | 5.8 |
| Example 6 | 993 | 5.5 | 6.8 |

TABLE 4

| Part Identification | Basis Weight | Part Depth | Stiffness |
|---|---|---|---|
| Comparative Example 7 | 1317 | 5.1 | 7.9 |
| Example 7 | 1488 | 5.4 | 9.4 |
| Example 8 | 1408 | 5.1 | 9.2 |
| Example 9 | 1419 | 5.2 | 9.2 |

What is claimed is:

1. A method of forming a molded fibrous construct, comprising the steps of:
a) forming a fibrous batt from staple length fibers comprised at least in part of thermoplastic polymer,
b) mechanically integrating the fibrous batt into a fibrous pre-form mat,
c) thermally treating the fibrous pre-form at a first elevated temperature for an initial duration,
d) cooling the fibrous pre-form to less than the first elevated temperature, and
e) thermoforming the thermally treated fibrous pre-form into a molded construct.

2. A method of forming a molded fibrous construct as in claim 1, wherein said staple length fibers are selected from the group consisting of natural fibers, synthetic fibers, and the blends thereof.

3. A method of forming a molded fibrous construct as in claim 2, wherein said staple length synthetic fibers are selected from a group consisting of polyacrylates, polyolefins, polyesters, and polyamides.

4. A method of forming a molded fibrous construct as in claim 2, wherein said staple length fibers are selected from a group consisting of cotton, wood pulp, rayon, and the combinations thereof.

5. A method of forming a molded fibrous construct as in claim 1, wherein said staple length thermoplastic fibers have a denier of at least 1.0.

6. A method of forming a molded construct as in claim 1, wherein said fibrous batt has a binder fiber composition of at least 50% by weight.

7. A method of forming a molded fibrous construct, comprising the steps of;
a) forming a fibrous batt from staple length fibers comprised at least in part of thermoplastic polymer,
b) mechanically integrating the fibrous batt into a fibrous pre-form mat,
c) thermally treating the fibrous pre-form at a first elevated temperature for an initial duration,
d) compressing the heated fibrous pre-form to a level less than an uncompressed fibrous pre-form and greater than the part depth a molded fibrous construct is to have,
e) cooling the fibrous pre-form to less than the first elevated temperature,
f) thermoforming the thermally treated fibrous pre-form into a molded construct.

8. A method of forming a molded fibrous construct, comprising the steps of;
a) forming a fibrous batt from staple length fibers comprised at least in part of thermoplastic polymer,
b) mechanically integrating the fibrous batt into a fibrous pre-form mat,
c) thermally treating the fibrous pre-form at a first elevated temperature for an initial duration,
d) compressing the heated fibrous pre-form to a level equal to the part depth a molded fibrous construct is to have,
e) cooling the fibrous pre-form to less than the first elevated temperature,
f) thermoforming the thermally treated fibrous pre-form into a molded construct.

9. A method of forming a molded fibrous compound construct, comprising the steps of;
a) forming a fibrous batt from staple length fibers comprised at least in part of thermoplastic polymer,
b) mechanically integrating the fibrous batt into a fibrous pre-form mat,
c) position at least one facing layer in face to face juxtaposition with the fibrous pre-form,
d) thermally treating the layered fibrous pre-form at a first elevated temperature for an initial duration,
e) cooling the layered fibrous pre-form to less than the first elevated temperature, and
f) thermoforming the thermally treated layered fibrous pre-form into a molded compound construct.

10. A method of forming a molded fibrous compound construct, comprising the steps of;
a) forming a fibrous batt from staple length fibers comprised at least in part of thermoplastic polymer,
b) mechanically integrating the fibrous batt into a fibrous pre-form mat,
c) position at least one facing layer in face to face juxtaposition with the fibrous pre-form,
d) thermally treating the layered fibrous pre-form at a first elevated temperature for an initial duration,
e) compressing the heated layered fibrous pre-form to a level less than an uncompressed fibrous pre-form and greater than the part depth a molded fibrous construct is to have,
f) cooling the layered fibrous pre-form to less than the first elevated temperature,
g) thermoforming the thermally treated fibrous pre-form into a molded compound construct.

11. A method of forming a molded fibrous compound construct, comprising the steps of;
a) forming a fibrous batt from staple length fibers comprised at least in part of thermoplastic polymer,
b) mechanically integrating the fibrous batt into a fibrous pre-form mat,
c) position at least one facing layer in face to face juxtaposition with the fibrous pre-form,
d) thermally treating the layered fibrous pre-form at a first elevated temperature for an initial duration,
e) compressing the heated layered fibrous pre-form to a level equal to the part depth a molded fibrous construct is to have,
f) cooling the layered fibrous pre-form to less than the first elevated temperature,
g) thermoforming the thermally treated layered fibrous pre-form into a molded compound construct.

12. A molded construct comprising,
a) a fibrous mat comprised at least in part of thermoplastic polymer,
b) said thermoplastic polymer comprised of at least one heat activated binder component,
c) said fibrous mat having been heated to the activation temperature of the binder component, then cooled to a temperature less than the activation temperature of the binder component.

13. A molded construct comprising a fibrous batt integrated into a fibrous pre-form mat, wherein:
said fibrous pre-form is subjected to an elevated temperature, compressed to a depth less than the uncompressed fibrous pre-form and greater than the part depth of the molded construct, cooled, and thermoformed.

14. A molded construct comprising a fibrous batt integrated into a fibrous pre-form mat, wherein:
said fibrous pre-form is subjected to an elevated temperature, compressed to a level equal to the part depth of the molded construct, cooled and thermoformed.

15. A molded construct comprising a fibrous batt integrated into a fibrous pre-form mat, wherein:
said fibrous perform comprises at least one facing layer, subjected to an elevated temperature, cooled, and thermoformed.

16. A molded construct comprising a fibrous batt integrated into a fibrous pre-form mat, wherein:
said fibrous perform comprises at least one facing layer, subjected to an elevated temperature, compressed to a level less than an uncompressed fibrous pre-form and greater than the part depth of the molded construct, cooled, and thermoformed.

17. A molded construct comprising a fibrous batt integrated into a fibrous pre-form mat, wherein:
said fibrous perform comprises at least one facing layer, subjected to an elevated temperature, compressed to a level equal to the part depth of the molded construct, cooled, and thermoformed.

18. A molded construct comprising a fibrous batt, which is integrated into a fibrous pre-form mat, having a stiffness performance of at least 15% greater than a molded construct devoid of a fibrous pre-form.

19. A molded construct as in claim 7, wherein said molded construct is an automotive interior panel.

20. A molded construct as in claim 7, wherein said molded construct is an appliance facing.

21. A molded construct as in claim 7, wherein said molded construct is an acoustic dampening shield.

22. A molded construct as in claim 7, wherein said molded construct is a domestic furnishing.
